(19) United States
(12) Patent Application Publication
(10) Pub. No.: US 2023/0231233 A1
(43) Pub. Date: Jul. 20, 2023

(54) ENERGRY GENERATION SOURCES, DEVICES AND SYSTEMS

(71) Applicant: Moshe J. Yan, Princeton, NJ (US)

(72) Inventor: Moshe J. Yan, Princeton, NJ (US)

(21) Appl. No.: 17/576,947

(22) Filed: Jan. 15, 2022

(51) Int. Cl. H01M 12/02; H01M 10/04; H01M 4/66; H01M 4/62

(52) U.S. Cl. CPC H01M 12/02; H01M 10/0459; H01M 4/661; H01M 4/625

(57) ABSTRACT

Energy sources embodying the invention include one or more cells, where each cell includes an electrode (anode or cathode) which is a non-metal and another electrode which is a metal or non-metal, with the electrodes positioned relative to each other to produce a potential differential. The electrodes may be placed in a water solution or kept in air (dry). They may be spaced apart or be in direct contact. A conduction enhancing layer may be placed between the electrodes.

### BACKGROUND OF THE INVENTION

This invention relates to the use of novel combinations of materials and configurations and reliance on phenomena such as gravitational forces for producing novel energy sources.

Reliance on gravitational forces is significant in that these forces are of great potential power as evidenced, for example, by the tides. Also, gravitational forces are always present in contrast to solar energy and wind energy.

It is also desirable that sources of energy use components which are cheap and easily obtainable so as to be affordable.

### SUMMARY OF THE INVENTION

One aspect of Applicant's invention is directed to energy sources in which one electrode (anode or cathode) is a non-metal and the other electrode is a metal or non-metal. Another aspect of Applicant's invention is reliance on gravitational phenomena to enhance the production of useful electric power and/or to self-recharging. Still other aspects of the invention are discussed below and set forth in the claims appended hereto.

Sources of energy embodying the invention include a first non-metallic electrode interacting with a second electrode, which may be metallic or of a non-metallic material, other than that used for the first electrode. The first and second electrodes are positioned relative to each other to produce a voltage differential. The first and second electrodes may be spaced apart or they may be in direct contact with each other, and/or an enhancing conduction layer may disposed between them. Connections are made to the first and second electrodes for enabling a load to be connected between said first and second electrodes. The second electrode may be a metal container containing an electrolyte

The enhancing conduction layer disposed between the first and second electrodes may include metal particles or ions and a mixture of powders which can be of metal or non-metal. The enhancing conduction layer may be contained within any suitable very thin porous structure (e.g., tea bag) which allows the migration of atomic particles therethrough. Alternatively, it may be an independently formed layer.

Sources of energy embodying the invention may thus include a sandwich comprised of a first electrode, an enhancing conduction layer and a second electrode disposed generally in parallel with each other. The enhancing layer may have one surface contacting the first electrode and an opposite surface contacting the second electrode. Alternatively, the layer may be in direct contact with the first or the second electrode and there may be a space between the electrode to which the layer is attached and the other electrode.

A multiplicity of energy sources embodying the invention may be connected in series to increase the voltage or in parallel to increase the current.

In a particular configuration, the first and second electrodes are grounded to earth and the presence of a potential differential can be measured. The existence of the potential differential evidences the generation of energy due to gravitational field forces since any force due to electromagnetic force would goes to earth and no voltage differential would be measured.

Varying amounts and degrees of moisture may be employed with the electrodes embodying the invention.

A source of energy (or energy cell) embodying the invention may also include first and second spaced apart electrodes placed in water or a water solution or in a container containing water (or any suitable liquid), where one electrode is a nonmetal and the other electrode is a different non-metal or a metal.

In accordance with the invention a non-metallic electrode may be a leaf (e.g., a tree leaf) or any organic substance ground like jam or juices mixed into particles. Alternatively, these organic substances may be used to form a layer in conjunction with first and second electrodes.

The electrodes and the enhancing layer may be placed in a container containing water or plant leaves or organics grinding like jam or juices mixed into particles. Organic nanoscale size particles may be added to the water in the container. A potential differential is sensed across the electrodes indicative of energy production.

For extended use, the container may include apparatus for selectively changing the water in the container and selectively injecting particles in the water.

A rechargeable energy source (or cell) embodying the invention may include, a first electrode contacting a first enhancing conduction contacting a central metal electrode. The central metal electrode in turn contacts a second enhancing conduction layer in contact with a second electrode. A switching apparatus may be coupled to the first and second electrodes and to the central metal electrode for selectively coupling a load between the central metal electrode and the first electrode and selectively decoupling the load between the first electrode and the central metal electrode and coupling the load between the central metal electrode and the second electrode.

The first and second electrodes of the rechargeable energy source may be non-metallic.

The first and second electrodes and the central metal electrode of a rechargeable energy source embodying the invention may be placed in a water filled container.

A multiplicity of energy sources embodying the invention may be mechanically coupled to a floating member lying on the surface of a body of water, with the floating member responsive to tidal forces. Selected ones of the multiplicity of energy sources may be selectively or automatically connected in series or in parallel. The multiplicity of energy sources may be connected in arrays with the arrays of energy sources (or cells) being selectively or automatically connected in series or in parallel by the switch and valves systems. The tidal movement of the float (responsive to gravitational forces) may be used to control the interconnection of the multiplicity of energy cells in the arrays, the alternate submerging of selected ones of these arrays and their operation.

### BRIEF DESCRIPTION OF THE DRAWINGS

In the accompanying drawings which are not drawn to scale like reference characters denote like components; and

FIGS. 1 and 1A are illustrative drawings of elements used to practice the invention;

FIGS. 1B and 1C are an illustrative drawing of elements used to practice the invention connected to ground;

FIG. 2 is an illustrative drawing of an energy producing configuration embodying the invention;

FIGS. 3 and 3A are illustrative drawings of an energy producing configuration embodying the invention, with the elements used to practice the invention in a water solution;

FIG. 3B is an illustrative drawing of a series connection of energy producing configurations;

FIG. 3C is an illustrative drawing of an energy cell embodying the invention, in which one of the electrodes (E2) is a metal container containing an electrolyte;

FIG. 4 is an illustrative drawing of a control system for modifying the water level and contents of an energy producing configuration such as shown in FIG. 3, 3A, 3B or 3C;

FIG. 5 is an illustrative drawing of a configuration embodying an aspect of the invention;

FIG. 5A is an illustrative drawing of another configuration embodying an aspect of the invention;

FIG. 6 is an illustrative drawing of a configuration embodying the invention coupled to a solar cell;

FIGS. 7, 7A and 7B are illustrative drawings of an organic material (e.g., foliage) combined with a metal electrode to from a source of energy in accordance with the invention;

FIG. 8 is an illustrative drawing of a source of energy (see FIG. 5A) embodying the invention placed in a water solution;

FIG. 9 is an illustrative drawing of a source of energy embodying the invention placed in a water solution with a switching control system to provide recharging of the electrodes of the system;

FIG. 9A is an illustrative drawing of a control mechanism for changing the water and the mineral content of the water solution in a source of energy shown in FIG. 9;

FIG. 9B is an illustrative drawing of another source of energy embodying the invention placed in a water solution with a switching control system;

FIGS. 10 and 10A are illustrative drawings showing the interconnection of cells embodying the invention in parallel or in series to increase the current or potential differential and their coupling to an inverter to produce alternating current (AC) voltages;

FIG. 10B is an illustrative drawing of a system in which a float responsive to the movement of the tides (and hence responsive to gravitational forces) is used in combination with arrays of cells embodying the invention to produce useful energy;

FIG. 10C is an illustrative drawing of another array of cells mechanically coupled to a float to produce useful energy;

FIG. 11 is an illustrative drawing of elements useful to practice the invention placed in a faraday cage used to block the effect of electromagnetic waves in order to demonstrate the presence of gravitational field;

FIG. 12 is a highly simplified semi-schematic semi-block diagram of a circuit (essentially a “gravitational wave energy battery”) embodying the invention; and

FIG. 13 is still another highly simplified semi-schematic semi-block diagram showing gravitational power producing circuitry combined with other power producing circuitry.

### DETAILED DESCRIPTION OF THE INVENTION

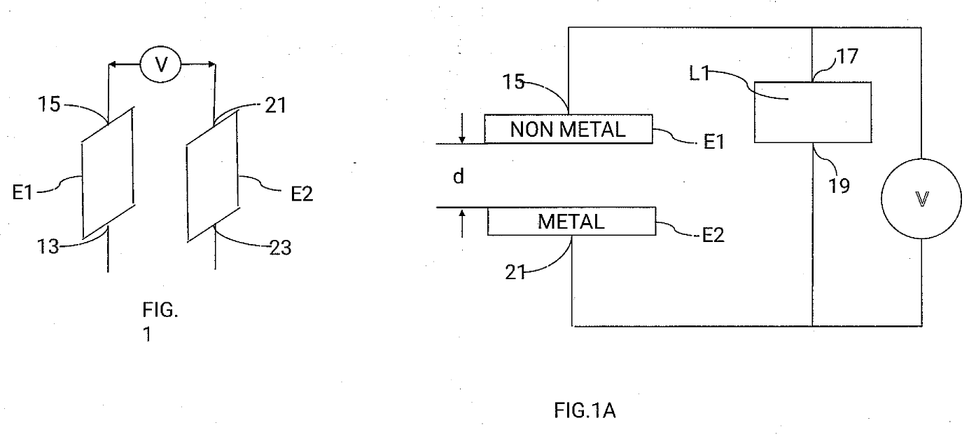

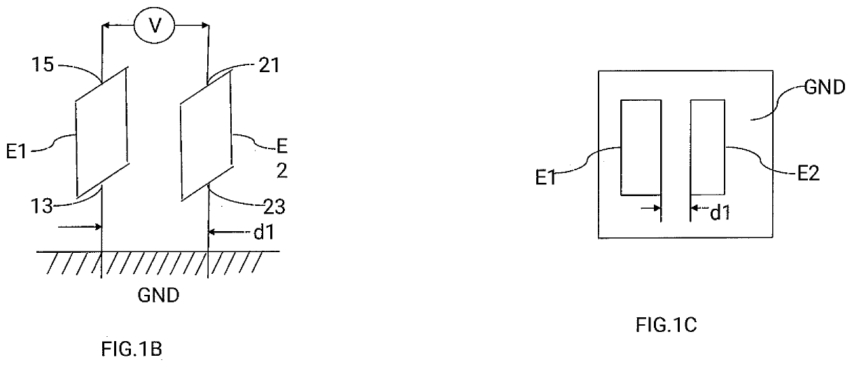

Referring to FIGS. 1 and 1A there is shown 2 spaced apart electrodes E1 and E2. E1 is a non-metallic electrode and E2 is a metallic electrode. In a particular experiment Applicant used a carbon fiber material (i.e., a non-metal) for E1 and an aluminum foil for E2. In one embodiment, the surface areas of E1 and E2 were approximately 2 square inches and their thickness approximately ⅛ of an inch. An exterior surface 15 of Electrode E1 may be connected to one side 17 of load L1 and the other side of load 19 of Load L1 may be connected to one surface 21 of electrode E2. The load L1 may be a resistive load with or without a capacitor connected in parallel with the resistive load. For a distance, d, of a few nanometers Applicant measured a voltage of approximately 600˜700 millivolts (mV). As the distance “d” between the electrodes was increased there was a decrease in the measured voltage. This demonstrates the use of a nonmetal electrode and a metallic electrode to produce a voltage differential useful as a source of energy.

In the discussion to follow it should be understood that electrodes (E1, E2) are positioned relative to each other to produce a potential differential. The shapes and surface areas and thicknesses of the electrodes (E1 and E2) used to practice the invention may be greatly varied. It should also be understood that the spacing (distance) between the electrodes may also be varied. With respect to the metallic electrodes used to practice the invention any of the known metal and alloys thereof are suitable for use. For the non-metallic electrodes, reference below is made to carbon fiber, organic matter (plant foliage) and cloth material. However, it should be understood that this is illustrative only and any suitable non-metallic substance can be used as a non-metallic electrode.

Referring to FIGS. 1B and 1C, an end 13 of electrode E1 is shown connected to earth ground and an end 23 of electrode E2 is shown connected to earth ground with a distance d1 between the ground returns 13 and 23. E1 was a strip of carbon fiber and E2 was a strip of aluminum foil. In one embodiment, see FIG. 1C, electrodes E1 and E2 were placed on ground (actual earth) surface. A voltage differential was measured across the electrodes E1 and E2. This again demonstrates the use of a nonmetal electrode and a metallic electrode to produce a voltage differential useful as a source of energy. As mentioned above, electrode E1 may be any suitable non-metallic substance and E2 may be any suitable metallic or non-metallic substance.

Applicant found the grounded earth configuration of 2 electrodes (E1, E2) as shown in FIGS. 1B and 1C, where one electrode is a metal and the other is a nonmetal (and even where both electrodes were of different metals) produced a potential differential. Thus, they (E1 and E2) still captured forces; but not electromagnetic force since electromagnetic currents will go to earth/ground. Applicant contends that the grounded configuration of FIGS. 1B and 1C confirms Einstein's space-time curved theory and the voltage obtained (read) for the grounded two electrodes/collectors (E1 and E2) must be due to the gravitational field force, not electromagnetic force. Because the electromagnetic currents would all go to earth and the voltage meter reading would read as “0”.

In one experiment (experiment A), for the “grounded” configuration of FIGS. 1B and 1C, E1 and E2 were, respectively, a copper sheet and an aluminum foil, and a voltage of 700 mV was measured. In another experiment (experiment B), for the “grounded” configuration of FIGS. 1B and 1C, E1 and E2 were, respectively, Zinc and a stainless steel sheets, and a voltage of 1.1V was measured over a distance of 0.5 inch-5 feet.

In further experiments (Experiment C and D) the two (metal or nonmetal) sheets (of experiment A and experiment B) were placed into a water bath or seawater and the potential differentials between E1 and E2 was the same as for the “grounded” earth.

From these experiment, it can be determined that measured potential differential between electrodes E1 and E2 is from gravitational force and that electrodes/collectors E1 and E2 could be: (a) one a metal and the other a non-metal; or (b) both being different non-metals, such as carbon with cotton cloth.

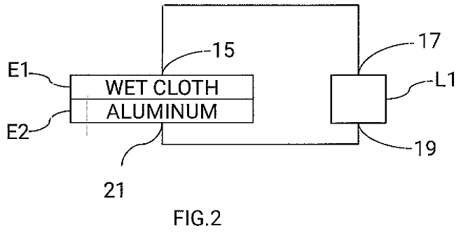

Referring to FIG. 2, there is shown an electrode E1, formed of a moistened cloth, placed over a layer of aluminum (E2). One end 17 of a resistive load (L1) was connected to a surface 15 of electrode E1 and another end 19 of the resistive load L1 was connected to a surface 21 of electrode E2. In one embodiment L1 was a 1K ohm resistor and a voltage in excess of 600 mV was measured. Thus, the combination produced a measurable current and voltage across the load. It should be understood that E1 may be any other suitable non-metal substance and that E2 may be any other suitable metal or even a non-metal other than the one used for E1. The cloth E1 of FIG. 2 may be moistened with tap water. Alternatively, mixed particles including ions may be added to the water moistening the cloth to produce larger voltages and currents.

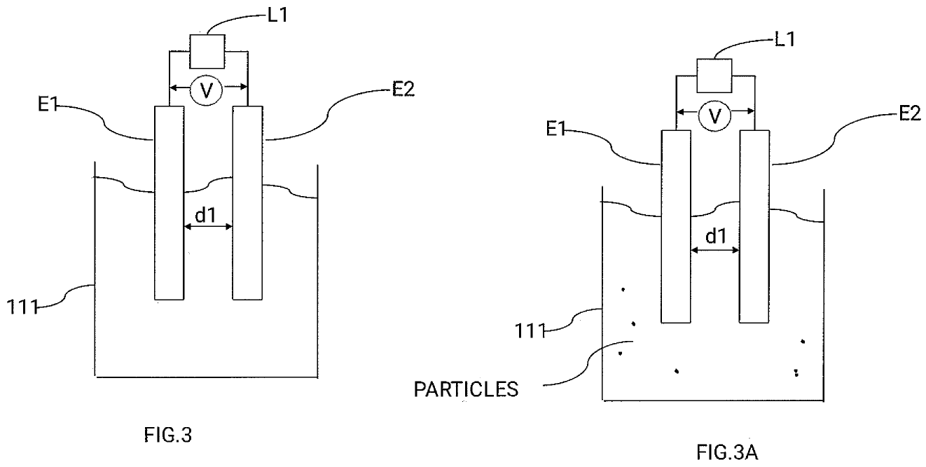

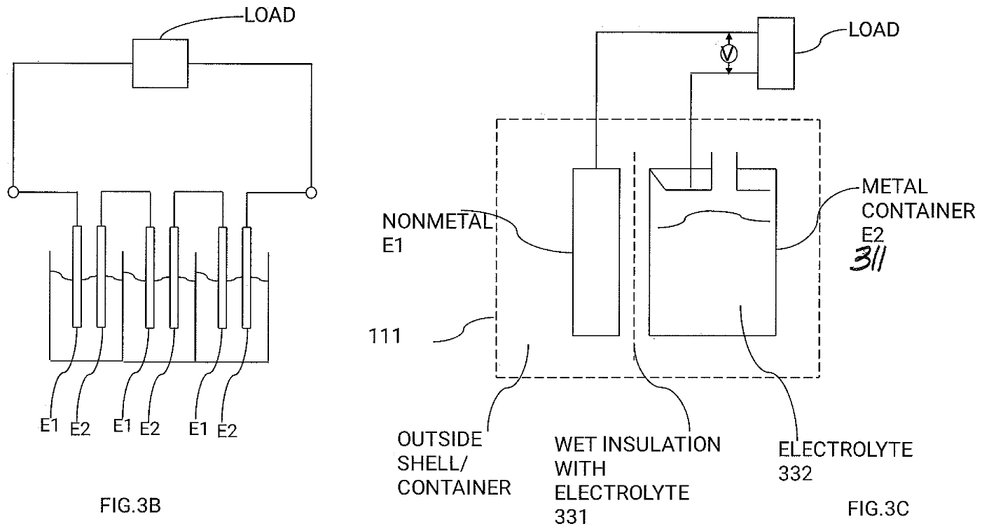

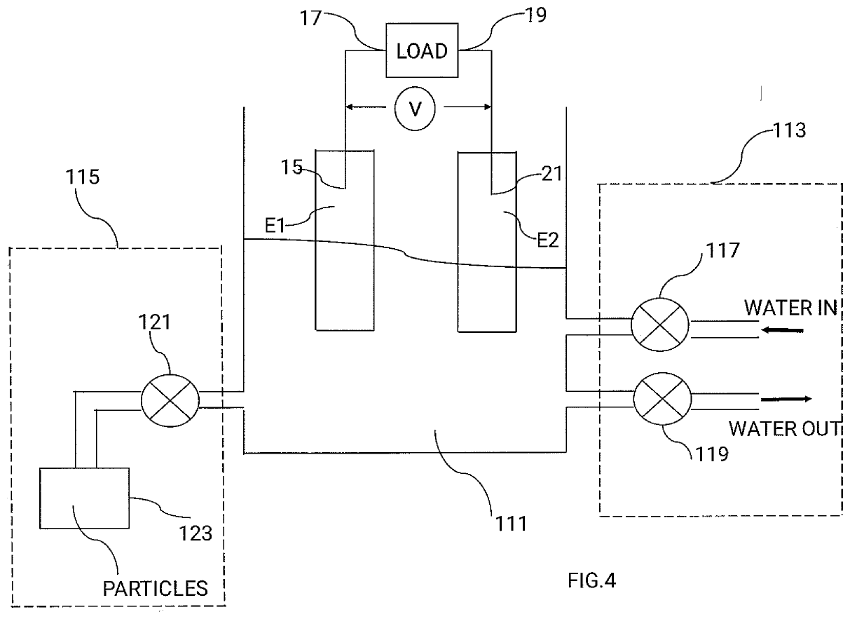

Referring to FIG. 3, there is shown a tap water filled enclosure 111 in which are immersed a non-metallic electrode E1 and a metallic electrode E2. In one experiment electrode E1 was a pad of carbon fiber and electrode E2 was an aluminum strip ½ inch wide and approximately 2 inches long. A resistive load, L1, of 1K ohms was connected across the electrodes. For distances, d1, ranging from a few nanometers to 5 centimeters sizable voltages and currents were measured across the load, L1. As above, E1 may be any suitable non-metallic material and E2 may be any suitable metal or a non-metal different than that used for E1.

The use of a non-metal electrode and a metal electrode or two different non-metallic electrodes defines over the prior art which shows and uses two metallic electrodes to produce energy sources.

Referring to FIG. 3A, electrodes E1 and E2 were similar to the like electrodes in FIG. 3, except that metal particles (an electrolyte) were added to the water. The measured voltages and currents were of greater amplitude than for the configuration of FIG. 3.

Referring to FIG. 3B, there is shown a series connection of the configuration of the components shown in FIG. 3 or 3A to provide a higher voltage across a load. FIG. 3B shows a series connection of three energy cells of the type shown in FIG. 3A or 3B. It should be understood that this is for purpose of illustration only and many more cells could be connected in series.

Potential differentials and currents were obtained when E1 and E2 were placed in a water solution (see FIGS. 3, 3A and 3B) for E1 and E2 being: (a) two different metals; (b) one a metal and the other a non-metal; and (c) both being different non-metals, such as carbon with cotton clothes and still generated a measurable potential. The water solution in which the electrodes are placed may be pure, tap water and/or particles may be added to enhance the potential differential.

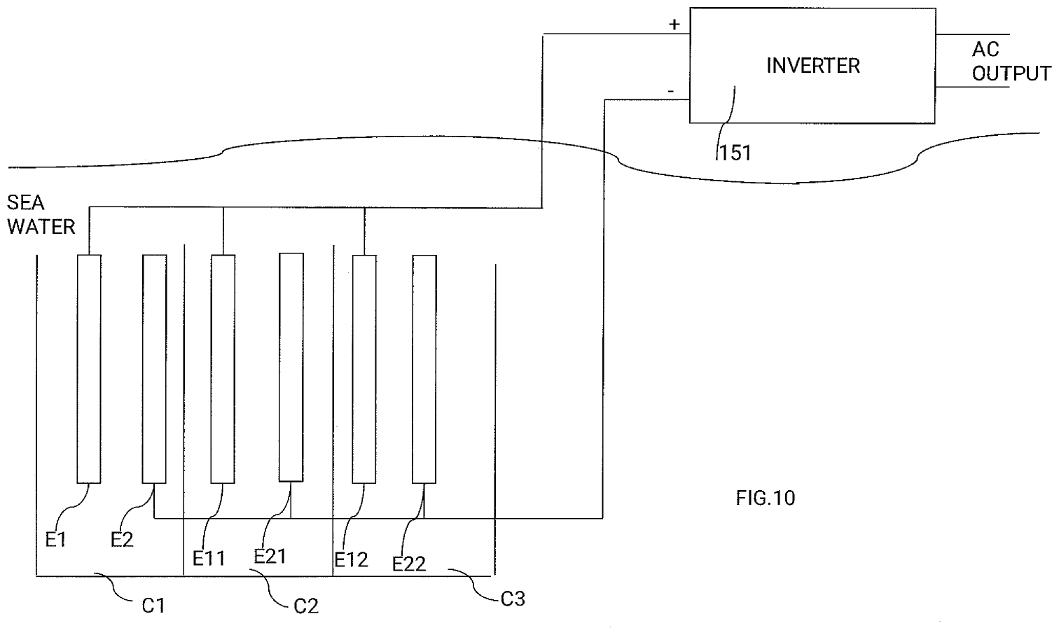

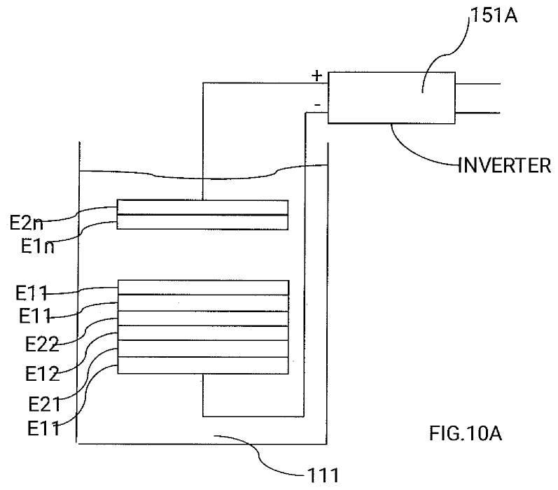

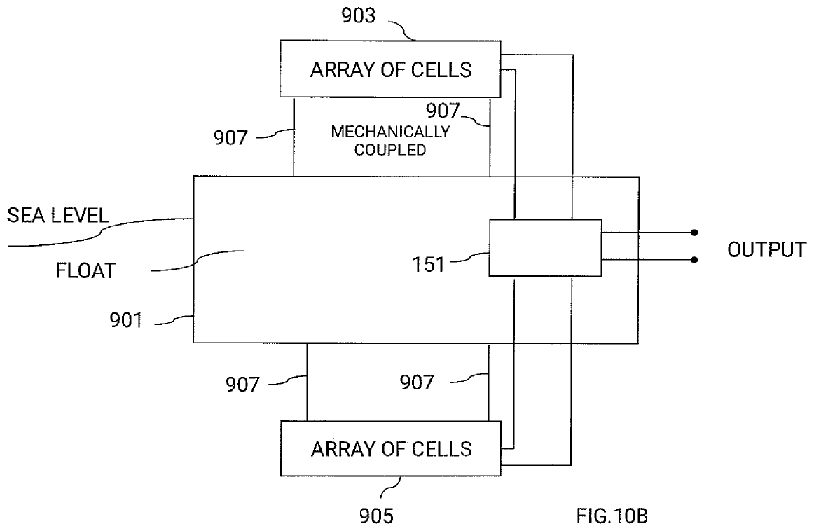

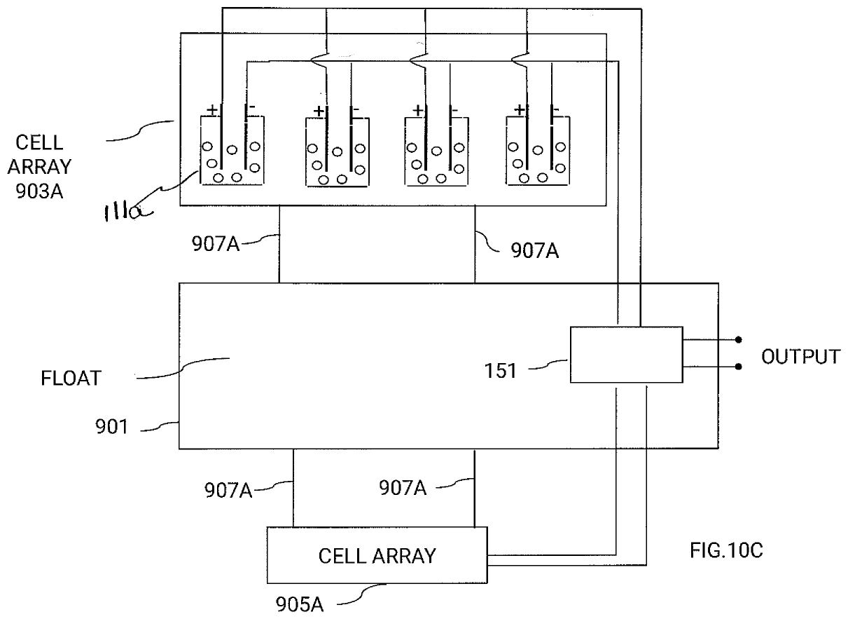

As shown in FIG. 3B, (see also FIGS. 10 and 10A) it should be appreciated that energy cells or sources embodying the invention may be connected in series (to boost the voltage) or in parallel (to boost the current) or in any combination of series and parallel. The use of capacitors and super capacitors for charge storage is understood in all the Figures (even where not shown). That is, capacitors may be connected across the load and across the electrodes of energy cells embodying the invention to store energy produced and meet load demands. These supercapacitors will be charged whenever the battery is working to supply load or not. So, these supercapacitors will supply power together to the devices which need large currents.

With respect to the water solution, since there is a gravity force potential and it transfers as an electromagnetic force, metals and/or nonmetals particles, powders or ions were mixed into a pure water and as a result, the gravity force will push the particles from one electrode to another electrode.

When the electrodes were immersed in seawater and the seawater contained many metals particles or ions, to produce larger currents. Thus, large currents (e.g., 36 mA) were measured for seawater.

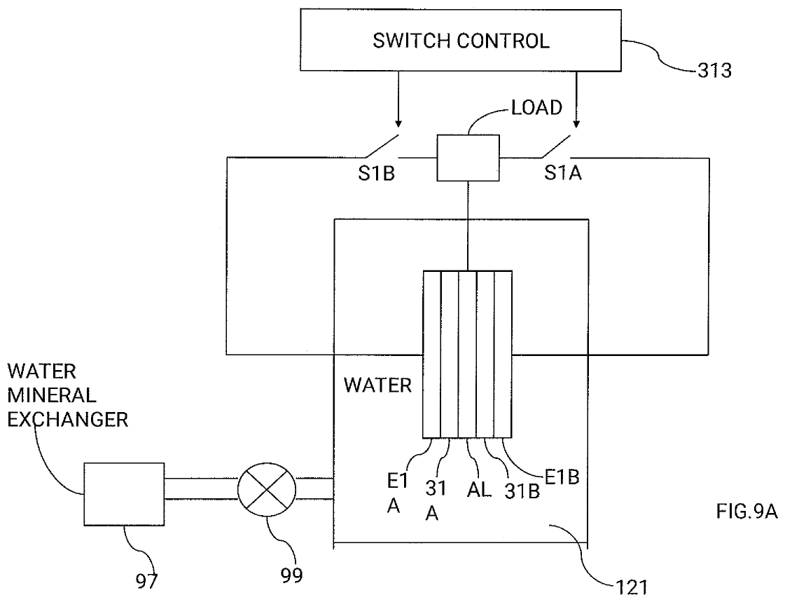

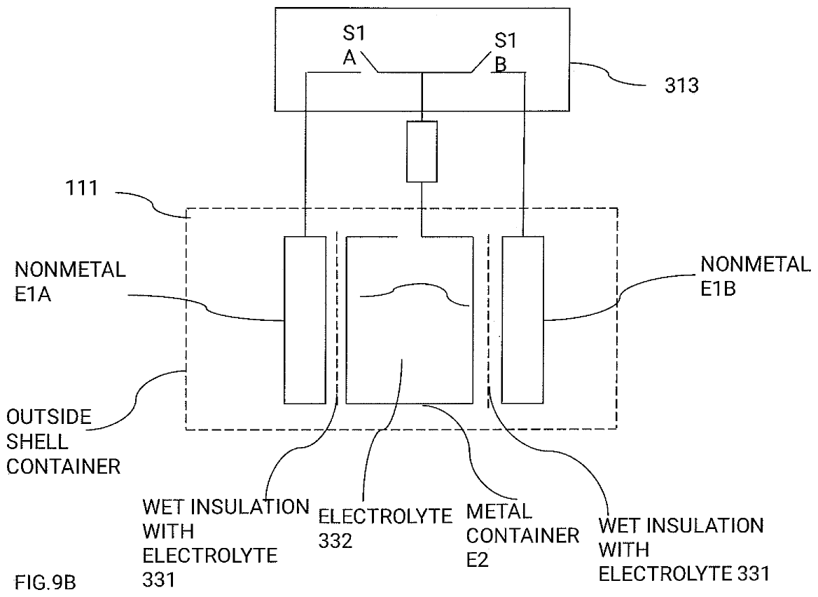

Referring to FIG. 3C there is shown an energy source of cell comprised of a water container 111 with a nonmetal electrode E1 and a metal electrode E2, where the metal electrode E2 is itself a container 311. An electrolyte 331 is added to the water in container 111 and an electrolyte 332 is added to the water in container 311. As used herein and in the appended claims, an “electrolyte,” may be any compound which produces ions when dissolved in a solution such as water. The electrolyte 332 in container 311 may not be directly involved in the interaction between E1 and E2. The voltage across the load may decrease with time as the effect of electrolyte 331 wanes. However, when the load is removed, the gravitational field force energy acting on electrolyte 332 in container 311 absorbs more gravity energy than electrolyte 331 and it will maintain a higher potential and it functions through the metal to effectively transfer electrical energy. So, E2 and electrolyte 332, and electrolyte 331 work together to pull the particles and ions emanating from E1 into electrolyte 331 and the particles and ions will move to E2. That is, the gravitational field force energy causes the particles and ions falling down from positive electrode to negative electrodes side. So, the battery is self-sustaining returning to its original energy level as shown, for example, in FIGS. 3C and 9B. The energy cell shown in FIG. 3C may be connected in series with any of the other cells embodying the invention, or any other suitable cell or arrangement. For example, the FIG. 3C energy cell could be connected in series with the cells shown in FIG. 3B, or instead of any of the cells shown. Also, the FIG. 3C energy cell could be connected in parallel with any other cell embodying the invention or any other suitable cell or arrangement. For example, The FIG. 3C energy cell could be any one of the cells (e.g., C1) shown in FIG. 10.

As shown in the figures, energy producing configurations embodying the invention may include: (a) a metal electrode (sheet or strip) and a non-metal electrode (sheet or strip); or (b) two non-metallic electrodes of different material. The electrodes may be spaced apart with a gap (distance) ranging from about 1 nm-2 mm. The electrodes may be formed to extend generally parallel to each other and may be spaced apart or in direct contact with each other or with a conduction enhancing layer between the electrodes.

To avoid “pitting” and ensuring the longer life of metal I electrodes, metal electrodes (e.g., aluminum or cooper or Zinc) in cells embodying the invention may be covered with another metal such as iron, which corrodes easily. So, for example, by putting a layer of iron on the surface of an aluminum electrode, higher voltage can be obtained and the “corroding” iron will protect the aluminum sheet from corrosion. The energy cell can thus last longer.

Referring to FIG. 4, all the components placed in a water container 111 may be the same as in FIG. 3 or 3A. However, there is added a water level control mechanism 113 for changing the water in the container 111 and a particle level control mechanism 115 for adding particles (enhancing the electrolyte). The water level control mechanism 113 includes a valve 117 for selectively or automatically adding water to container 111 and a valve 119 for selectively or automatically draining water from container 111. The particle level control mechanism 115 includes valve 121 and a source of particles 123 for selectively or automatically adding electrolyte to container 111. The source of particles 123 may include ions, and any suitable particles for enhancing conduction.

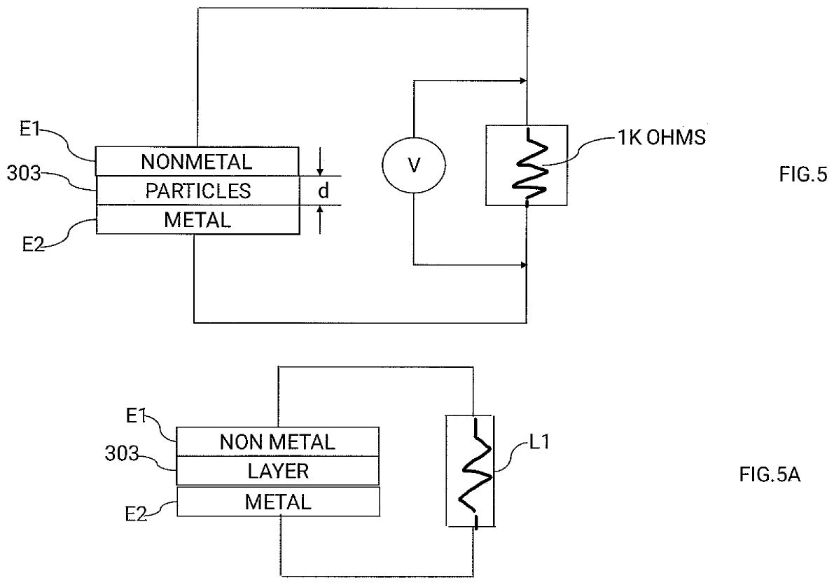

Referring to FIGS. 5 and 5A there are shown configurations in which an enhancing layer 303 is placed between two electrodes E1 and E2. Enhancing layer 303 may include metal or non-metal particles or powders or ions, or any substances enabling increased conduction. The contents of layer 303 may be contained within any appropriate very thin material container or pouch material (e.g., like a tea bag) which may (but not necessarily) be of thin insulating material. The pouch/bag/container 303 functions as a separator placed in a thin gap between the two electrodes, E1 and E2. FIGS. 5 and 5A are examples of a “dry” battery, i.e., one not requiring any liquid.

In FIG. 5, there is shown a nonmetal layer E1, and spaced therefrom by a distance, d, an enhancing layer 303 overlying and in contact with a metal layer E2. For distances of d1, between E1 and E2, where d1 may range from a few nanometers to 2 millimeters sizable voltages were measured across a load of 1K ohms connected across the electrodes E1 and E2. It should be understood that the layer 303 may be in direct contact with electrode E1 and there being a space between the layer and E2.

Referring to FIG. 5A the space “d” is eliminated and the three layers E1, 303 and E2 overly and are in direct contact with each other. As noted above, enhancing layer 303 may include metal particles or powders or like substances enabling increased conduction. A potential differential exists between the two electrodes, evidencing the configuration as a source of energy. When a load L1 is connected between the two electrodes, the load is powered due to the gravitational force pushing or pulling the particles from negative side to positive side of the electrodes.

In the configurations shown in FIGS. 5 and 5A, E1 and E2 may be two different non-metallic substances or a metal and a non-metal.

The two electrodes are disposed relative to each other such that a potential differential exists between the two electrodes, evidencing the configuration as a source of energy. Applicant contends that this is due to the gravitational field force acting across the layers. Thus, when a load L1 is connected between the two electrodes, the load is powered due to the gravitational force pushing or pulling the particles from negative side to positive side of the electrodes.

As shown in FIGS. 5 and 5A, in accordance with the invention, the intermediate layer (e.g., 303) of metallic or nonmetal particles and/or any number of powders, can be placed between the two electrodes. Applicant asserts there is a gravitational force between the electrodes, which provides results similar to those obtained with the electrostatic effect. Thus when a load is connected across the electrodes the particles, and powders from the intermediate layer will travel from one electrode (the negative side) to the other electrode (positive side) and currents flow through the load forming a full circuit.

The advantage of this gravitational force battery is that the gravitational potential is always present.

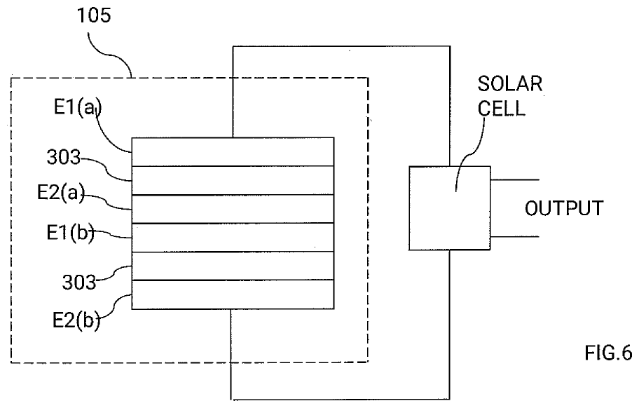

Referring to FIG. 6—there is shown energy source 105 comprised of an electrode E1a overlying a layer 303a overlying an electrode E2a which in turn overlies an electrode E1b which overlies a layer 303b which overlies an electrode E2b. A solar cell is connected across the configuration (i.e., between the top surface of E1a and the bottom surface of E1b).

The solar cell is comprised of silicon N and P junctions. Due to gravitational field forces, the energy source 105 connected across the solar cell will supply power to the solar cell. So connected, the energy source will make the solar cells or electrons from the two different silicon regions (P/N) move to different sides. So, we can with 2 outlets to connect to a load for supply power from the silicon. The energy source 105 functions as sunlight and causes the solar cell's to respond as if sunlit.

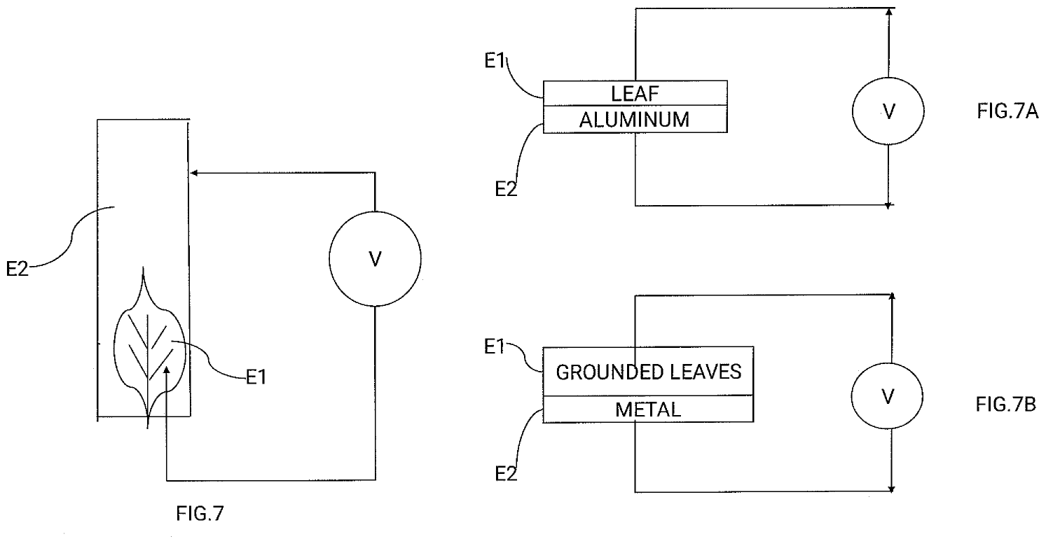

Referring to FIGS. 7 and 7A, there is shown an electrode E1 selected to be a leaf of a tree. In one experiment, E1 was placed in direct contact with an electrode E2 formed of a layer of aluminum foil. In another experiment, E2 was selected to be a cotton cloth. A voltage was measured across the combination and a useful potential differential was measured. This demonstrates that organic plants (e.g., a leaf) can provide energy and can be used as an energy source which applicant contends may be due to gravitational field force energy.

In FIG. 7B, electrode E1 was a layer of grounded leaves. Applicant contends that this grinding/grounded leaves made like jam or juice and this liquid like contained gravity force inside and also added a mixture of ions metal or nonmetal particles or powder to enhance the currents and voltage. Thus, environmentally friendly materials can be chosen to form an energy source embodying the invention.

As shown in FIGS. 7, 7A and 7B, leaves or leave products are used to illustrate that any like organic material may be used to form an electrode placed in direct contact with a metal or any different non-metal to produce a useful voltage differential.

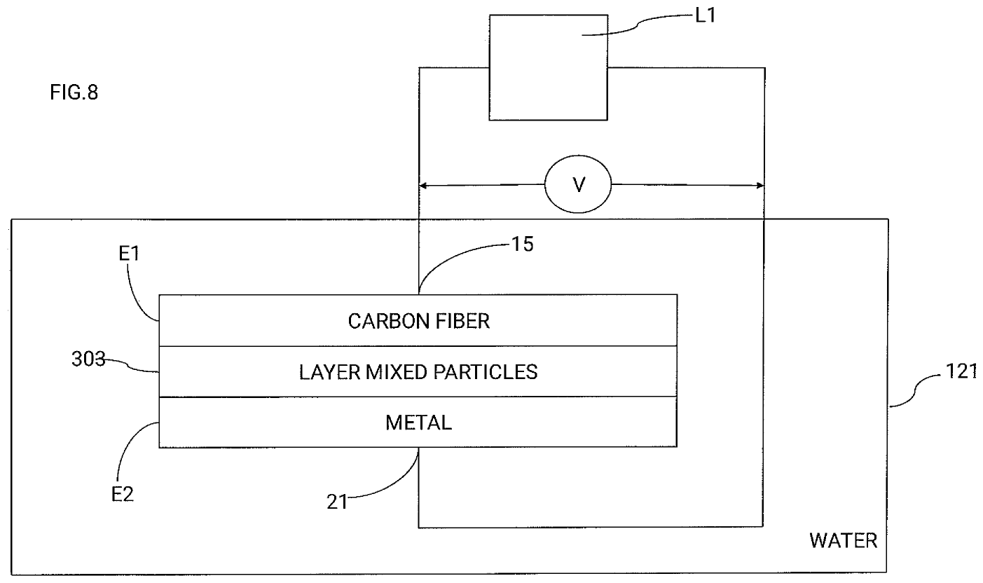

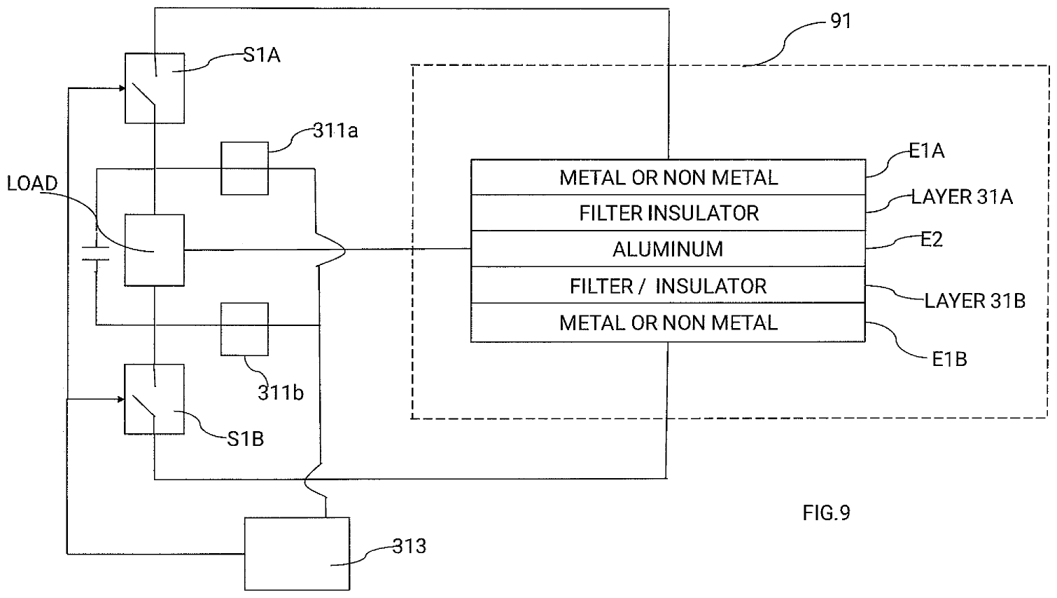

Referring to FIG. 8, there is shown an energy cell configuration similar to that of FIG. 5A, except that the electrodes E1 and E2 and the layer 303 between the electrodes are immersed in a water pouch 121. In one embodiment a non-metallic electrode E1 was of a carbon fiber material, electrode E2 was an aluminum foil, and layer 303 was a thin cotton layer filled with carbon and metal powders. A sizable voltage and current was produced across and through a load L1 connected (as shown in FIG. 8) between the top surface 15 of E1 and the bottom surface 21 of E2. As noted above, E1 and E2 may also be two different non-metallic substances.

FIGS. 9, 9A and 9B illustrate configurations in which a source of energy (energy cell or battery) embodying the invention are “rechargeable” or self-sustainable for extended periods of time.

Referring to FIG. 9 there is shown an energy cell 91 comprised of an electrode E1A overlying a filter/insulator layer 31A which overlies a metallic electrode E2 (e.g., aluminum). Electrode E2 overlies a layer 31B which overlies an electrode E1B. In FIG. 9 and in FIGS. 9A and 9B, there is formed a sub-cell comprised of E1A and E2 and another formed of E2 and E1B. The sub cells may be alternatively coupled across the load. While one of the sub cells is connected across the load the other sub cell is being recharged (refreshed or reenergized). Note that the term “overlying” is used for purpose of illustration to describe the showing in FIG. 9. It should be understood that (see FIG. 9A) the electrodes and layer are disposed relative to each other to produce a potential differential. Generally, they will extend parallel to each other, but that is not a necessary condition. In FIG. 9A the energy cell 91 of FIG. 9 is placed in a water pouch 121 and a water level and mineral density exchanger 97 can control a valve 99 to control the water level and the particles/minerals added to the water in the pouch 121.

In FIGS. 9 and 9A, electrode E2 overlies/contacts a filter/insulator layer 31B which overlies/contacts an electrode E1B. In this configuration electrodes E1A and E1B may be metal or non-metal. Layers 31A and 31B may be similar to layers 303 discussed above. A control switching network 313 couples the load between the electrodes so as to selectively switch the charging and discharging of the device. In an embodiment, E1A and E1B were strips of carbon fiber, E2 was a strip of Aluminum and layers 31A and 31B included carbon and metal particles contained within a non-conductive very thin porous packet. Switches S1A and S1B controlled by network 313 are used to switch the load so that it is powered by E1A and E2 or by E1B and E2. Voltage or current sensors 311a, 311b feed signals to the switch control 313 to cause switching of switches S1A and S1B.

Assume that initially switch S1A is closed and switch S1B is open. The load is then connected between electrodes E2 and E1A. The amplitude of the current flowing through the load due to the action of E1A and E2 is sensed by sensor 311a. When sensor 311a senses a predetermined decrease in the current, it will send a signal to switch control 313. Switch control 313 then sends a signal to turn off (open) switch S1A and turn on (close) switch S1B. The load will then be powered by the action of E2 and E1B. Sensor 311b, in a similar manner to 311a, will sense the amplitude of the current flowing through the load due to the E1B to E2 connection. When sensor 311b senses a predetermined decrease in the voltage or current flowing it will send a signal to switch control 313. Switch control 313 then sends a signal to turn off (open) switch S1B and turn on (close) switch S1A. The switching back and forth recharges the discharging of the electrodes and can keep the energy cell 91 generating energy for an extended period of time.

Thus, a triple electrode battery is shown in FIG. 9. Electrodes E1A and E2 initially supply power to the load. With switch S1A turned on (closed) and switch S1B turned off (open), the particles or ions from E2 (e.g., the negative electrode) travel to electrode E1A (e.g., the positive electrode) and the system flow from E2 to E1 goes to let say left side. With switch S1B turned on (closed) and switch S1A turned off (open), electrode E2 and E1B working the system pushed and pulled all particles/ions from E2 to electrode E1B that it is from left side goes to right side. This time the battery is as same as charged the electrode E1A (falling the particles and ions) with electrode E2 together. So, this kind battery will keeping long time and back for the charged itself.

Referring to FIG. 9B there is shown an energy configuration which includes a cell similar to that shown in FIG. 3C. There is included a water container 111 with non-metal electrodes E1A and E1B (interfacing with an electrolyte 331) and a central metal container 311 (filled with an electrolyte 332) functioning as electrode E2. The load may be switched between E1A and E2 or between E2 and E1B, as in FIGS. 9 and 9A. The functioning and actions of electrolytes 331 and 332 are similar to that discussed for FIG. 3C, above.

Assume that initially the load is connected between electrodes E1A and E2 (switch S1A is closed and switch S1B is open), the loading may cause the voltage across the load to decrease. Sensing means (see FIG. 9) then open switch S1A and close switch S1B so that the load is now across electrodes E2 and E1B. When that happens, the energy force potential between E1A and E2 functions to charge back to their original potential level by interaction of electrolyte 331 and electrolyte 332. So, the battery returns to its original state having been recharged. Similarly when the sensed voltage across the load is below a predetermined level, S1B is opened and S1A is closed and “recharged” electrodes E1A and E2 function to power the load while electrodes E1B and E2 are recharged or refreshed.

In one embodiment, electrodes E1A and E1B were carbon fiber and E2 was an aluminum can 311 filled with an electrolyte 332. The switching of the load was as explained above. The aluminum can is filled with seawater (or a suitable electrolyte).

The electrode E2 (container 311 functions as a negative electrode). But the electrolyte 332 inside container 311 does not react directly with the operation between E1A (or E1B) and E2 which power the load. Electrolyte 332 is independent but it is contained with larger quantity of water and receives more gravitational field force energy than electrolyte 331 which is lightly wetted with slight amounts of electrolyte.

When the load is removed from a cell (e.g., E1A and E2), the load, the gravitational field force energy in the electrolyte 332 absorbs more gravity energy than electrolyte 331 and it's always keep higher potential. Concurrently, the aluminum container 311 is metal and it transforms the electric between the can (aluminum to inside can electrolyte 332 and outside electrolyte 331). The inside conditions of de container electrolyte 332 do not mix with electrolyte 331 and the particles inside the container never goes to another side electrode (positive side). So, the electrolyte 332 inside the container do not lose their potency, maintaining a high level of gravitational field force potential. When the load is removed, this higher potential helps the E1A, E2 energy back to the original force potential level. So, when one sub cell (e.g., E1A and E2) is powering the load, the other sub-cell (e.g., E2 and E1B) is being recharged.

Referring to FIG. 10 there is shown three energy cells (C1, C2, C3) immersed in water connected in parallel to increase the current output. In FIG. 10A there is shown “n” energy cells immersed in water connected in series to increase the potential differential. In FIG. 10 the parallel outputs of the cells are applied to an inverter 151 and in FIG. 10A the serial outputs of the cells are applied to an inverter 151A. Inverters 151 and 151A function to produce an AC voltage.

Referring to FIG. 10B, there is shown a float 901, riding on the surface of body of water (sea or ocean), subject to rise and fall of the tides. Arrays (903 and 905) of energy generating cells embodying the invention are mechanically coupled to the float by members 907. Two arrays are shown, but a multiplicity could be used. The electrical output of the arrays of energy cells is shown connected to an inverter 151 mounted on the float to produce an AC voltage. The energy cells can be connected in series or parallel (as shown in FIGS. 10 and 10A). The arrays 903 and 905 are mechanically connected via members 907 to the float 901 so the energy producing cells can be immersed in and out of sea water by movement of the float in response to tidal movement. Alternatively, the energy cells may be left in the water, but then a valve control system would be required to open a multiple-series switching in a predetermined sequence to exchange the water within the cells. A paralleled-series connections with a switch system controls the configuration of the energy cells. A switching control can selectively or automatically connect the cells in parallel to increase the available currents or in series to increase the voltage differential. One or more array of cells (e.g., 903 or 905) can be fully operational while another array is being reenergized (immersed).

Arrays of cells (e.g., batteries) can be mounted on the seashore with tides line (not shown). During “high” tide the batteries will be submerged in seawater and the batteries absorb new seawater. During “low” tide, energy cells embodying the invention can supply power since inside the energy cells insulation materials such as cotton cloth contained seawater. This type of system can keep on reenergizing the energy cells.

Referring to FIG. 10C, there is shown arrays of cells (903A, 905A), each cell within a container 111a having openings (holes) which can be selectively or automatically opened or closed to exchange the water in the cell. The holes can be blocked or opened by controlled switch (not shown) circuitry operated in a selective or automatic manner. The battery holes of the cells can be opened one cell at a time, so all the batteries are independent. Then, they can then be interconnected in parallel or series and and/or multiple-series connections and all the batteries can be submerged.

In FIG. 10C the array of cells may be mechanically coupled under the float by member 907A so as to be submerged inside the seawater in series or parallel arrangements.

FIG. 10C is a balance container control system working with switch and series changing or an arch pulled by tide force and always with one side batteries submerged into seawater and they absorbed new seawater with ions to supply the energy. When tide off the loosing of string will let the side always into seawater since that side is heavier than other one. So, the system always has one side submerged into the seawater.

Voltage boosting arrangements (not shown) may also be used to increase the voltage applied to the inverter.

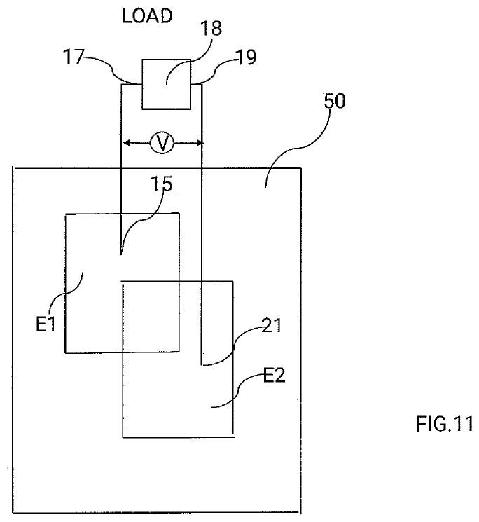

Referring to FIG. 11 there is shown the energy source of FIG. 1 placed in a faraday cage 50. The faraday cage blocks electromagnetic factors from affecting the energy source of FIG. 1. Using the faraday cage enables the measurement of gravitational effects and make use of these effects to produce energy and or to sense differences due to gravity.

The collectors E1, E2 with metal or nonmetal pairs to receive the gravitational field force by the air and the meter can measure from 150 mV to 3.8V. To obtain higher voltages, in one instance the FIG. 11 device was placed on a table with some electromagnetic devices. Because the gravitational force can been absorbed by the so large grid network system and the cable of the devices pulled the gravity forces on the nearby such on the table. Even without turning on the power devices, the electrodes/collectors produced a voltage greater than 3 volts. Since the electrodes/collectors were in a Faraday cage, the voltage produced must be due to gravity force.

Arrays of sensors/collectors of the type shown in FIG. 11 can be used to connect with a power or currents enhancing chips then go to a computer programs the frequencies differences and make a see through wall radar or long ranges radars. Because gravity exist everywhere and every object moving effect the gravitational field wave/frequencies changes. So, this system with its sensors/collectors can receive the gravitational field waves/frequencies changes and we use AI techniques to make the images on the screen to follow the moving objects.

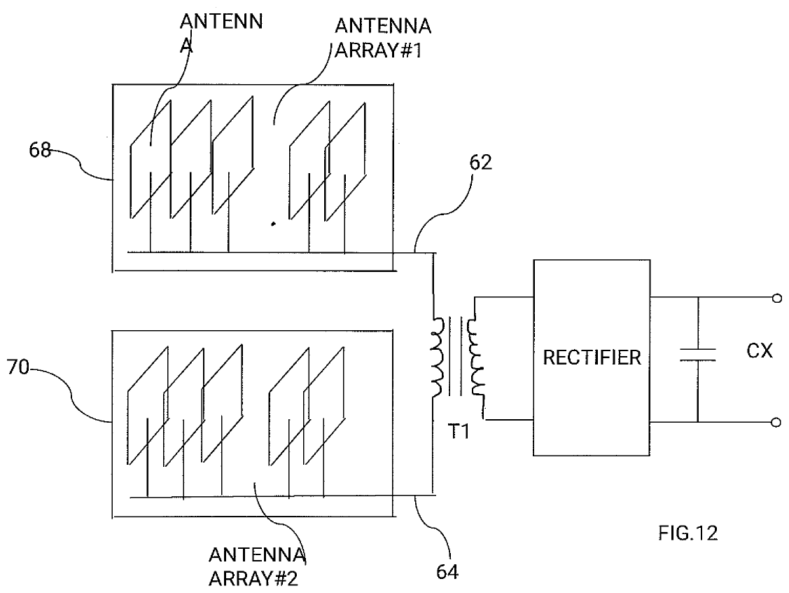

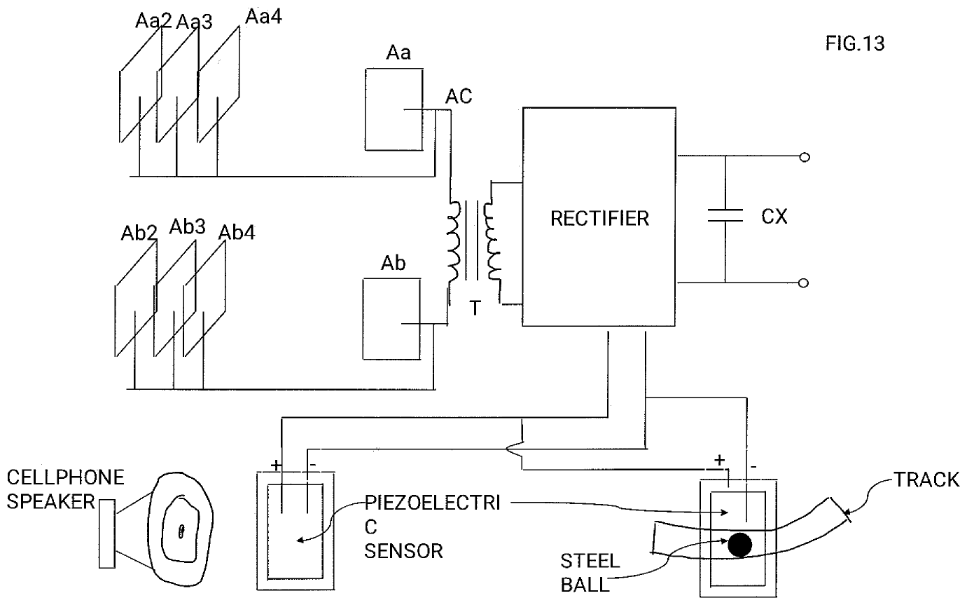

FIGS. 12 and 13 relate to a gravitational battery. In FIGS. 12 and 13 an array of antennas (electrodes, collectors or sensors) mounted within a mesh cage functions to harvest energy impinging on the antenna array. In FIGS. 12 and 13 the electrodes in array 68 and 70 may be metal or non-metal, so long as the elements in array 68 are different than those in array 70. The outputs of the antenna array are processed to produce a useful source of DC energy. It should be appreciated that the DC voltages can be fed to converters to produced AC voltages as well.

In FIG. 12, a first array of antennas, covered by a mesh 68, is connected to one side (62) of the primary of a transformer T1 and a second array of antennas, covered by a mesh 70, is connected to the other side 64 of the primary side of transformer T1. The antenna array functions to harvest gravitational wave energy impinging on the antenna array. The AC wave energy is coupled from the primary side to the secondary side of transformer T1. The secondary side of Transformer T1 is connected to a full wave rectifier to produce a DC voltage across a capacitor or a set of capacitors, Cx, which functions like a battery and which can be used to as an energy source for any desirable use.

Gravitational energy is a very powerful source of energy. For example, tides are very long-period waves that move through the oceans in response to the forces exerted by the moon and sun. Tides originate in the oceans and progress toward the coastlines where they appear as the regular rise and fall of the sea surface. Since so big quantity of sea water have been forced moving by the sun and moon with the Earth movements together caused the ocean tides. From the ocean tides that we can see there's big power potential for us.

Making use of gravitational energy wave to produce a source of DC energy has not been done before. Applicant's gravitational energy battery is a good example for capturing the gravity frequency/waves energy for free and continually supplying energy to selected devices. Thus, a battery, in accordance with the invention, is formed which can be automatically charged by gravitational waves.

For moving objects, such as cars, ships, planes trains, etc . . . , can make the gravitational waves changes and reversed that when the objects moves on itself when we put on the antennas or the sensors as one pieces of outside shell for antenna 1, or inside isolation materials as antenna 2 Or just Use the pieces of antennas attached to the outside even inside the vehicles, ship or airplane to get the energy.

This gravitational battery system is good for cars, planes, ships, trains, speeding or spinning wheels and even space ship charging and power supply. A multiplicity of antennas may be used for charging.

In FIG. 13 the antenna arrays are not disposed within a mesh cage. In this embodiment all signals received by the antenna arrays are applied across the primary of a transformer whose secondary is applied to a full wave rectifier to produce a useful DC output across capacitor Cx. In addition, FIG. 13 shows that other energy producers (e.g., piezo-electric devices and associated circuitry) may be added to the circuit to provide additional energy to the capacitors Cx. FIG. 13 shows the addition of piezoelectric sensors to charge the gravitational battery. The piezo electric devices may be energized by a speaker or by means of movements of a heavy steel ball on a track to always push/pressure the piezoelectric devices to produce the DC power to the super capacitors, Cx. A piezoelectric sensor may be placed close to a speaker such that the vibrations of the speaker will affect the piezoelectric thin film sensor and it will also supply DC power to the super capacitors Cx. Thus, the gravitational charger circuit and the thin film piezoelectric sensor circuits can charge the super capacitors Cx to generate power which can power any selected device.

Thus, as shown, the gravitational battery output can also be charged by other sources of energy such as piezoelectric devices and associated circuitry. Note that even electromagnetic energy harvesting circuitry could be used to provide additional charge to the “gravitational battery”. The gravitational battery can charge the capacitors Cx which then supply power to a device such as cellphone. So, there are many ways to add charge and power to a gravitational energy battery system, if and when more power is needed.

What is claimed is:

1. A source of energy comprising:
a number N of energy producing cells, where N is an integer equal to or greater than one;
each one of said cells including:
a first non-metallic electrode;
a second electrode; said second electrode being either metallic or a non-metallic electrode, different than said first electrode;
said first and second electrodes being positioned relative to each other to produce a voltage differential between the first and second electrodes; and
connections to said first and second electrodes for enabling a load to be connected between said first and second electrodes.

2. A source of energy as claimed in claim 1, wherein said first electrode is in direct contact with said second electrode.

3. A source of energy as claimed in claim 2 wherein said first electrode is moistened.

4. A source of energy as claimed in claim 1, wherein said first and second electrodes are spaced apart.

5. A source of energy as claimed in claim 4, further including a conduction enhancing layer containing metal particles being located between the first and second electrodes.

6. A source of energy as claimed in claim 4, wherein said enhancing layer has a top and bottom surface; and wherein the top surface of the enhancing layer is in direct contact with the first electrode and the bottom surface of the enhancing layer is in direct contact with the second electrode.

7. A source of energy as claimed in claim 1, wherein said first electrode is composed of organic material.

8. A source of energy as claimed in claim 7, wherein said first electrode includes at least one of a plant leaf, ground organic material forming a jam, and a mixture or juices and particles and such materials known to enhance conductivity.

9. A source of energy as claimed in claim 4, further including a container of water and wherein said first and second electrodes are placed in the container.

10. A source of energy as claimed in claim 9, further including at least one of particles, ions, mixtures of metallic powders or non-metallic powders, and organic nanoscale size particles added to the water in the container.

11. A source of energy as claimed in claim 9 further including means for selectively changing the water in the container and selectively injecting particles in the water.

12. A source of energy as claimed in claim 1, wherein said first electrode is nonmetallic, wherein said second electrode is metallic, and further including a third non-metallic electrode disposed relative to the second electrode so as to produce a potential differential; and further including a first conduction enhancing layer between the first and second electrodes and a second conduction layer between the second and third electrodes; and
further including a switching apparatus coupled to the first, second and third electrodes for selectively coupling the load between the second electrode and the first electrode and decoupling the load between the first electrode and the second electrode and for selectively coupling the load between the second electrode and the third electrode and decoupling the load between the first electrode and the second electrode.

13. A source of energy as claimed in claim 12, wherein said switching apparatus includes sensors responsive to the voltage across the load for controlling the coupling and decoupling of the load.

14. A source of energy as claimed in claim 12 wherein said first, second and third electrodes and said first and second conduction layers are placed in a water solution.

15. A source of energy as claimed in claim 1, wherein selected ones of said N cells are located within containers mechanically coupled to a floating member located in sea water; wherein said mechanical coupling enables the selected cells to be immersed in sea water and for exchanging the sea water within the containers for increasing the energy produced by said selected ones of said N cells.

16. A source of energy as claimed in claim 1, wherein said load may be resistive, capacitive or inductive or a combination thereof.

17. A source of energy as claimed in claim 1, wherein said second electrode is a metal container with an electrolyte present within the container.

18. A source of energy comprising:
a first and a second array of energy producing cells; wherein each one of said energy producing cells includes a first non-metallic electrode and a second electrode which may be metallic or nonmetallic; said first and second electrodes being configured relative to each other to produce a voltage differential between the first and second electrodes; and connections to said first and second electrodes for enabling a load to be connected between said first and second electrodes;
a floating member intended to be located on the surface of a body of water so as to be responsive to movement of the body of water;
said first array of energy producing cells being located within a first submergible structure and said second array of energy producing cells being located within a second submergible structure;
apparatus mechanically coupling the first and second submergible structures to the float including means for selectively submerging the first and second submergible structures and changing the water content in the submergible structures; and
means electrically connecting the outputs of said first and second array of energy producing cells to a load.

19. A source of energy as claimed in claim 18, wherein said load is an inverter.

20. A source of energy comprising:
a number N of energy producing cells, where N is an integer equal to or greater than one;
each one of said cells including:
a first electrode;
a second metallic electrode;
a third electrode;
first and second conduction enhancing layers, said first conduction enhancing layer positioned between said first and second electrodes and said second conduction enhancing layer being positioned between said third and second electrodes; g coupled between acing aid second electrode being either metallic or a non-metallic electrode, different than said first electrode;
said first, second and third electrodes and said first and second conduction enhancing layers being positioned relative to each other to produce a voltage differential between the first and second electrodes and between the second and third electrodes; and
a switching apparatus coupled to the first, second and third electrodes for selectively coupling a load between the second electrode and the first electrode and decoupling the load between the first electrode and the second electrode and for selectively coupling the load between the second electrode and the third electrode and decoupling the load between the first electrode and the second electrode.
